(19) United States
(12) Patent Application Publication
(10) Pub. No.: US 2002/0138968 A1
(43) Pub. Date: Oct. 3, 2002

(54) Method of manufacturing rotor core member for permanent-magnet alternating-current generator

(76) Inventors: Hirotoshi Kato, Hitachi City (JP); Tadayuki Ito, Hitachi City (JP); Katsumi Kato, Hitachi City (JP); Masaharu Yoshizawa, Hitachi City (JP)

Correspondence Address: Edward M. Keating, COOK, ALEX, McFARRON, MANZO,, CUMMINGS & MEHLER, LTD., 200 West Adams Street - Suite 2850, Chicago, IL, 60606, US

(21) Appl. No.: 10/072,138

(22) Filed: Feb. 11, 2002

(30) Foreign Application Priority Data
Mar. 28, 2001 (JP) 2001-093843

(51) Int. Cl. H02K 15/02; B23P 19/00

(52) U.S. Cl. 29/598; 29/736

(57) ABSTRACT

A method of manufacturing a rotor core member provided with concave angular portions for fixing permanent magnets at both sides of the inside faces of pole piece fingers by means of only a forging technique only includes the steps of forming a segment of a material having a predetermined volume into a preliminary core blank, which includes a plurality of pole piece fingers, having an angle of 70° relative to the plane extended from the bottom face of the integral disc section, removing the forging burr produced around the periphery of the integral disc section and at the both sides of the pole piece fingers of the preliminary core blank by means of die-cutting, then, die-cutting using the punch on the upper die or cope to form a shaft aperture in the central boss section of the preliminary core blank, at the same time, while drawing the pole piece fingers by means of drawing processing using the die face of the upper die or cope for forming out side surface, bending the same until the angle relative to the integral disc section becomes 90°, whereby the inside surfaces of the pole piece fingers are pressed onto the die face of the lower die or drag for forming the pole piece fingers resulting in forming the concave angular portions at the both sides thereof, and further, re-pressing the preliminary core blank as well as removing the forging burrs produced during the step by means of die-cutting to obtain a finished core member having precise predetermined dimensions.

### BACKGROUND OF THE INVENTION

1. Field of the Invention

The present invention relates to a method of manufacturing a core member for an alternating-current generator having a rotor in which a pair of rotor core members provided with a plurality of pole piece fingers are coupled facing to each other and in which permanent magnets are fixed between the pole piece fingers of the facing rotor core members. In particular, the present invention relates to a method of manufacturing a core member for permanent-magnet alternating-current generators used in vehicles and vessels.

2. Description of the Related Art

Generally, a rotor for alternating-current generators of this type is comprised of two rotor core members coupled with each other. The rotor members include a central boss section, an integral disc section extending radially outwardly in the same plane as the external end face from the periphery of the boss section and a plurality of pole piece fingers projecting from the periphery of the integral disc section in parallel to the axis of the boss section. The two rotor core members are coupled each other so that the boss sections come into contact with and face each other and so that the respective pole piece fingers thereof are interleaved in the recessed portions between the respective pole piece fingers, thus engaging and fixing the shaft and in the shaft is engaged and fixed therewith.

In many cases, a field coil is disposed around the external periphery of the boss section and it is arranged that when the field coil is excited, the individual pole piece fingers alternately generate polarities which are different from each other. When the rotor having such structure rotates, a rotating magnetic field is applied to an armature disposed outside the rotor.

In vehicular alternating-current generators, it has recently been proposed that, in place of the above-mentioned field coil, permanent magnets be disposed between the above-mentioned pole piece fingers. In this case also, it is obvious that, when the rotor provided with these magnets is rotated, a rotating magnetic field is applied to the armature disposed around it. However, in this case, it is necessary to form fixing means for fixing the permanent magnets at corresponding side positions of the pole piece fingers of the rotor core member. That is to say, it is necessary to form, for example, concave angular portions.

As for conventional manufacturing methods of a rotor core members of this type for alternating-current generators, generally, hot forging processing, cold forging processing, and plate bending processing techniques are known, and these techniques have been developed separately and applied to practical use. Although each technique has various inherent advantages and disadvantages, from the view point of technical development, a manufacturing method which employs mainly forging techniques is superior to the others. The applicant of the present invention has continued to improve mainly the forging techniques.

In connection with this, a manufacturing method of a rotor core member for alternating-current generators currently used by the applicant of the present invention (Japanese Unexamined Patent Application Publication No. 11889/1995; hereinafter, referred to as the current manufacturing method) is as described below.

That is, the method of manufacturing a rotor core member for permanent-magnet alternating-current generators includes the steps of:

forming a segment of a material having a predetermined volume into a preliminary core blank which includes a central boss section having dimensions approximating those of a finished core member, and an integral disc section extending around the periphery thereof, and a plurality of pole piece fingers projecting at predetermined angular intervals from the integral disc section, in which the pole piece fingers are a little smaller in length than those of the finished core member and an angle thereof relative to the plane extended from the bottom face of the integral disc section is 45° to 80°, the forming being carried out by means of forging using a set of dies having an interior structure in which a die cavity for forming the pole piece fingers rises at an angle of 45° to 80° from the plane extended from the bottom face of the die cavity for forming the integral disc section;

removing a forging burr produced in the above-mentioned step around the periphery of the integral disc section as well as at both sides of the pole piece fingers of the preliminary core blank by means of die-cutting;

forming a shaft aperture at the center of the boss section of the preliminary core blank by means of die-cutting, at the same time as drawing the boss section by means of drawing processing, bending the pole piece fingers 90° relative to the integral disc section to obtain predetermined dimensions; and further

re-pressing the preliminary core blank to obtain a finished core member having precise predetermined dimensions.

The above described current manufacturing method has solved the disadvantages of the manufacturing method conventionally carried out by means of a combination of techniques of hot forging processing, cold forging processing, and machining processing (hereinafter, referred to as the conventional manufacturing method).

One of the improvements is a step in the process of the conventional manufacturing method in which a material is hot forged first to form a preliminary core blank approximating the finished core member.

In this step, described roughly, a material having a predetermined volume is formed into a preliminary core blank which includes a boss section approximating the finished core member in dimensions, and an integral disk section, and a plurality of pole piece fingers a little smaller in length projecting from the above-mentioned integral disc portion. Since the preliminary core blank is, actually, just a preliminary blank, the pole piece fingers have already been formed so that the angle relative to the integral disc portion at that point of time is 90°. Also, a set of dies for forming the preliminary core blank are separated into an upper die or cope and a lower die or drag adjacent to the external periphery of a die cavity for forming the above-mentioned integral disc portion.

Accordingly, when forming the preliminary core blank, even when a compressive force is downwardly applied to the drag and a material placed thereon, the downward compressive force by the above-mentioned cope does not make the material directly flow to the upper portion of the die cavity for forming the individual pole piece fingers rising at an angle of 90°. As a result, it causes a forging burr of an amount exceeding the predetermined volume to be extruded between the cope and the drag, i.e., adjacent to the external periphery of the integral disc section. Because of this, the pressure within the dies is increased to cause the material to flow upwardly to the upper portion of the die cavity for forming the individual pole piece fingers.

Consequently, in the above-described step, the extrusion of a certain amount of forging burr is inevitable in order to ensure the extension of the pole piece fingers up to the predetermined length. Accordingly, in the above-mentioned conventional manufacturing method, an extra volume of the material equal to the forging burr is needed and this results in a decrease of the material yield equivalent to the extra volume.

In the current manufacturing method, the above-mentioned disadvantages concerning the material yield have been solved in a manner such that, when the preliminarily core blank is formed at the first step, the pole piece fingers projecting from the integral disc section are formed so that the angle relative to the integral disc section is 45° to 80°. As a result, the material is made to flow well into the die cavity of the dies for forming the piece fingers. Moreover, the necessity to produce a forging burr to increase the pressure within the dies has been eliminated.

The second improvement is the step in which the obtained preliminary core blank is formed into that having the correct volume.

The relevant step in the above-mentioned conventional manufacturing method is the step, described roughly, in which a preliminary core blank obtained by the hot forging processing is gradually air-cooled, and then is corrected into that having the appropriate volume by carrying out machining processing on both end faces of the boss section and the external faces of the integral disc section of the preliminary core blank. This step includes a machining processing different in nature from the others within a series of forging processes. This prevents the whole process from being fully automated.

In the current manufacturing method, the step before this step has been changed, as described above, so that the accuracy is increased, resulting in elimination of this step.

In the current manufacturing method, as described above, the disadvantages of the conventional manufacturing method, i.e., the disadvantage concerning the material yield and the disadvantage due to a machining processing of a different type from the others not necessary included in the process, have been solved.

Both the current and conventional manufacturing methods are methods for manufacturing rotor core members including rotor field coils. Therefore, based on these manufacturing methods of rotor core members, we examined the manufacture of rotor core members for permanent magnet generators. That is to say, a manufacturing method of a rotor core member provided with concave angular portions as means for fixing permanent magnets at the sides of the pole piece fingers was examined.

As a result of this, we have concluded that, in the conventional manufacturing method, it is difficult to form concave angular portions for fixing permanent magnets at the sides of the pole piece fingers in the forging process, and forming these by means of machining or the like is unsuccessful. That is to say, in this case, as described above, while forming a preliminary core blank, since the pole piece fingers are formed parallel to the central boss section, in other words, since they are formed at an angle of 90° relative to the integral disc section, it is difficult to form concave angular portions at the sides of the pole piece fingers in the following step or to structure the dies that enables to from the concave angular portions.

Whereas, the current manufacturing method has been improved with the goal of, as described above, increasing the material yield in the above-mentioned manufacturing method, and to make it possible to fully automate the whole process by using the forging processing only without utilizing any process which is different from the others. This goal has been achieved, but by further improving the manufacturing method, we have discovered the possibility of forming the concave angular portions for fixing permanent magnets at the sides of the pole piece fingers without utilizing machining processing, which is a technique different from the others.

### SUMMARY OF THE INVENTION

Accordingly, it is an object of the present invention to provide a method of manufacturing a rotor core member for a permanent-magnet alternating-current generator, i.e., a method of manufacturing a rotor core member provided with concave angular portions for fixing permanent magnets at the sides of the pole piece fingers, by utilizing forging technique, which is an excellent technology with high accuracy.

Further, it is another object of the present invention to provide a method of manufacturing a rotor core member for a permanent-magnet alternating-current generator, which allows automatic manufacturing of a rotor core member provided with concave angular portions for fixing permanent magnets at the sides of the pole piece fingers, by utilizing a forging technique only without utilizing a machining technique such us cutting or the like.

Accordingly, the invention was made with the purpose of achieving the above-mentioned objects. To this end, according to the present invention, there is provided a method of manufacturing a rotor core member for permanent magnet alternating-current generators, including the steps of:

forming a segment of a material having a predetermined volume into a preliminary core blank which includes a central boss section having dimensions approximating those of a finished core member, an integral disc section extending around the periphery thereof, and a plurality of pole piece fingers projecting at predetermined angular intervals from the integral disc section, the pole piece fingers being a little smaller in length than those of the finished core member and an angle thereof relative to the face extended from the bottom face of the integral disc section being 45° to 80°, said forming being carried out by means of forging using a set of dies having an interior structure in which a die cavity for forming the pole piece fingers rises at an angle of from 45° to 80° from the face extended from the bottom face of the die cavity for forming the integral disc section;

removing a forging burr produced in said forming step around the periphery of the integral disc section and at the both sides of the pole piece fingers of the preliminary core blank by means of die-cutting;

forming a shaft aperture by means of die-cutting at the center of the boss section of the preliminary core blank while, at the same time, drawing by means of drawing processing, bending the pole piece fingers to 90° relative to the integral disc section, and whereby the inside surface of the pole piece fingers are pressed onto a die face of a lower die for forming the pole piece fingers resulting in forming the concave angular portions for fixing permanent magnets to the insides at the both sides of the pole piece fingers; and

re-pressing the preliminary core blank whereby a finished core member having precise predetermined dimensions is obtained.

That is to say, the invention is a method of manufacturing a rotor core member for permanent magnet alternating-current generators by carrying out preliminary core blank forming processing, forging burr die-cutting processing, pole piece finger forming processing and repressing processing, in that order.

The above-mentioned preliminary blank forming processing is carried out by forming a material having a predetermined volume into a preliminary blank using predetermined dies.

The above-mentioned material having a predetermined volume may be obtained, for example, by press cutting a round bar to have predetermined dimensions.

After that, as shown in FIG. 1A and FIG. 1C, the element is forged to form into a preliminary blank having a structure and dimensions approximating the finished core member using a set of dies 13 having an internal structure in which the angle θ formed by die cavities 131 for forming pole piece fingers 40 and a plane 133 extended from the bottom face of a die cavity 132 for forming an integral disc section 30 is within a range of 45° to 80°.

The above-mentioned dies 13 are, described more precisely, dies in which the die cavities 131 for forming the pole piece fingers 40 rise at an angle θ within a range of 45° to 80° relative to the plane 133 extended from the bottom face of the die cavity 132 for forming the above-mentioned pole piece fingers 30. Among faces defining the above-mentioned internal die cavity, the lower side, i.e., the face having materials oriented upwardly is comprised of a lower die or drag 134; whereas, the upper side, i.e., the face having elements oriented downwardly is comprised of an upper die or cope 135.

The forging using the above-mentioned dies 13 may be carried out by means any of hot forging, warm forging, or cold forging. Needless to say, the respective requirements such as the strength of the dies 13 and required pressure or the like should be adjusted based on respective conditions.

Further, a preliminary core blank 60 obtained by means of the above-mentioned forging, described more precisely, as shown in FIG. 1C, is provided with a central boss 20 having a structure and dimensions approximating a finished core member, the integral disc section 30 extending outwardly in the radial direction from the edge, and the plurality of pole piece fingers 40 which extend from the above-mentioned integral disc section 30, a little smaller in size than those of the finished core member, wherein the angle θ relative to the plane 133 extended from the bottom face of the above-mentioned integral disc section 30 is 45° to 80°. Accordingly, in order to from the above-mentioned preliminary core blank 60 into a finished core member, the bending angle of the pole piece fingers 40 is 10° to 45°.

The above-mentioned angle θ is determined based on the experiments and experiences. When a material placed on the drag 134 is pressed by the cope 135, by virtue of the above-mentioned angle θ, and since the cope 135 and the drag 134 are separated as described above, the material is allowed to flow very well into the die cavities 131 of the dies for forming pole piece fingers 40. Described more concretely, as a result of the above-mentioned structure, escaping space for the material is eliminated between the cope 135 and the drag 134 when pressing is carried out, and the flow direction of the material is made optimum to flow. However, in case where the angle θ is set outside the above-mentioned range, the effect described above is not obtained.

In the above-mentioned forging burr die-cutting process, subsequent to the above-described forming step of the preliminary core blank 60, as shown in FIG. 1B, a forging burr 50 thinly produced on the periphery of the integral disc section 30 and the pole piece fingers 40 during formation of the preliminary core blank 60 is removed by means of die-cutting.

In the above-mentioned formation of the pole piece fingers 40, after completing the above-mentioned forging burr die-cutting process, as shown in FIG. 1D, using a set of dies 14, a shaft aperture is die-cut in the central boss 20 of the above-mentioned preliminary blank 60 by means of a punch 143 at the center of upper die or cope 141 and a die 144 at the center of a lower die or drag 142, at the same time as drawing the pole piece fingers 40 by means of drawing processing using a die face 145 defining the die cavity of the cope 141 for forming outside faces of the pole piece fingers 40, the pole piece fingers 40 are bent until the angle become 90° relative to the integral disc section 30, and, by virtue of the bending processing, the inside faces of the pole piece fingers 40 are pressed against the die-face 146 of the drag 142 for forming the inside faces of the pole piece fingers 40 resulting in the formation of convex angular portions for fixing permanent magnets at both sides thereof.

At this time, as shown in FIG. 2A and FIG. 1D, in case the die face 146 of the above-mentioned drag 142 for forming the inside faces of the pole piece fingers 40 are structured such that convex angular portions 147 corresponding to the above-mentioned concave angular portions at both sides thereof as well as at respective sides of the respective convex angular portions 147 are formed with a notch 148 for producing a thin sword-guard-like space between the die face 145 defining the die cavity of the above-mentioned cope 141 for forming outside faces of the pole piece fingers 40, it is possible for the above-mentioned concave angular portions 147 of the pole piece fingers 40 to be easily formed into a status in which the side thereof facing the central boss section 30 is notched. When the above-mentioned pole piece fingers 40 are bent to 90° relative to the cope 141 for forming outside faces of the pole piece fingers 40 by the die face 145 defining the die cavity, since the inside face thereof is formed by being pressed against the die face 146 of the drag 142 for forming inside faces of the pole pieces 40, at a point when the inside faces are formed, pressing to substantially 90° is made from both sides. Accordingly, the forming is carried out effectively.

Further, as shown in FIG. 2B, in a case where the die face 146 of the above-mentioned drag 142 for forming the inside faces of the pole piece fingers is structured such that both sides thereof are provided with convex angular portions 149 corresponding to the above-mentioned concave angular portions, on the other hand, the die face 145 defining the die cavity of the above-mentioned cope 141 for forming the outside faces of the pole piece fingers is structured so as to be a little larger in diameter in order to provide a little space between the outside faces of the convex angular portions 149 of the drag 142, while the above-mentioned forming processing is carried out, and a piece of sword-guard like burr is extruded into the spaces from both sides of the pole piece fingers 40. As a result, concave angular portions are easily formed at both sides of the inside faces of the pole piece fingers.

Finally, in the above-mentioned re-pressing step, a preliminary blank obtained by means of the above described pole piece finger forming step is re-pressed to complete a finished core member having precise predetermined dimensions.

### BRIEF DESCRIPTION OF THE DRAWINGS

FIG. 1A is a schematic sectional view illustrating the outline of a set of the dies used for forming a material into a preliminary core blank;

FIG. 1B is a schematic plan view illustrating a preliminary core blank formed using the above-mentioned dies, but forging burrs are not yet removed therefrom;

FIG. 1C is a schematic sectional view of the preliminary core blank formed using the above-mentioned dies, forging burrs have been removed therefrom, which is cut away between the pole piece fingers at both sides through the center thereof;

FIG. 1D is a sectional schematic view illustrating the state in which the preliminary core blank is set on a die used for forming a shaft aperture in the preliminary core blank from which forging burrs have been removed as well as for forming concave angular portions for fixing permanent magnets to the pole piece fingers;

FIG. 2A is a partial transverse sectional view of a part of an example of a set of the dies illustrating a die face of a lower die or drag for forming the inside surfaces of pole piece fingers and a die face of an upper die or cope which defines a die cavity for forming the external surface of the pole piece fingers;

FIG. 2B is a partial transverse sectional view of a part of another example of a set of dies illustrating a die face of a drag for forming the inside surface of pole piece fingers and a die face of a cope which defines a die cavity for forming the external surface of the pole piece fingers;

FIG. 3 is a schematic perspective view illustrating a press-cut material;

FIG. 4 is a schematic sectional view illustrating the outline of a set of the dies used for forming a material into a preliminary core blank;

FIG. 5A is a schematic sectional view of a preliminary core blank formed using the above-mentioned dies, which is cut away between the pole piece fingers at both sides through the center thereof;

FIG. 5B is a schematic plan view illustrating the preliminary core blank formed using the above-mentioned dies;

FIG. 6A is a schematic sectional view of the preliminary core blank from which forging burrs have been removed by means of die cutting, which is cut away between the pole piece fingers at both sides through the center thereof;

FIG. 6B is a schematic plan view illustrating the preliminary core blank from which forging burrs have been removed by means of die cutting;

FIG. 7A is a schematic sectional view illustrating the state of a set of dies in which the preliminary core blank, from which forging burrs have been removed, is set on the drag, the dies are in the process of forming a shaft aperture, bending the pole piece fingers to 90° relative to the integral disc section and forming the concave angular portions for fixing permanent magnets at both sides of the individual pole piece fingers by lowering the cope;

FIG. 7B is a schematic sectional view illustrating the state of the set of dies which has completed a process forming a shaft aperture, bending the pole piece fingers to 90° relative to the integral disc section and forming the concave angular portions for fixing permanent magnets at both sides of the individual pole piece fingers on the preliminary core blank, from which forging burrs have been removed and is placed on the drag, by lowering the cope;

FIG. 7C is an enlarged transverse sectional view illustrating a mating portion of the set of dies between the die face of the drag for forming the inside surface of the pole piece fingers and the die face of the cope which defines a die cavity for forming the external surface of the pole piece fingers;

FIG. 8A is a schematic sectional view illustrating the preliminary core blank which has been formed with a shaft aperture and the pole piece fingers thereof have been processed using the above-mentioned dies, which is cut away between the pole piece fingers at both sides through the center thereof;

FIG. 8B is a plane view illustrating the preliminary core blank, which has been formed with a shaft aperture and the pole piece fingers thereof has been processed using the above-mentioned dies;

FIG. 9 is an enlarged view of the portion A in FIG. 8B;

FIG. 10 is a schematic sectional view illustrating the state of a set of dies for re-pressing the preliminary core blank which has been formed with a shaft aperture, in which the pole piece fingers thereof have been processed, and in which re-pressing has been completed;

FIG. 11A is a schematic sectional view illustrating the re-pressed preliminary core blank, which is cut away between the pole piece fingers at both sides through the center thereof;

FIG. 11B is a plan view illustrating the re-pressed preliminary core blank;

FIG. 12A is a schematic sectional view of a finished rotor core member, which is cut away between the pole piece fingers at both sides through the center thereof;

FIG. 12B is a plane view of the finished rotor core member;

FIG. 13A is an enlarged side view illustrating a state in which a pair of the finished rotor core members are coupled facing to each other; and

FIG. 13B is a sectional view of the pair of finished rotor core members coupled facing to each other, which is cut away at a portion where the individual boss portions come in contact with each other.

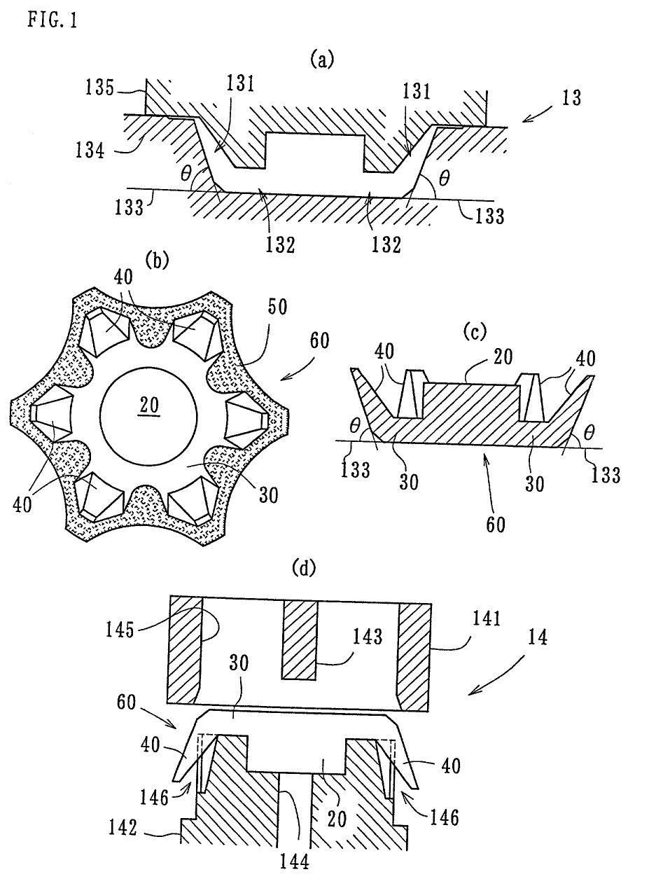

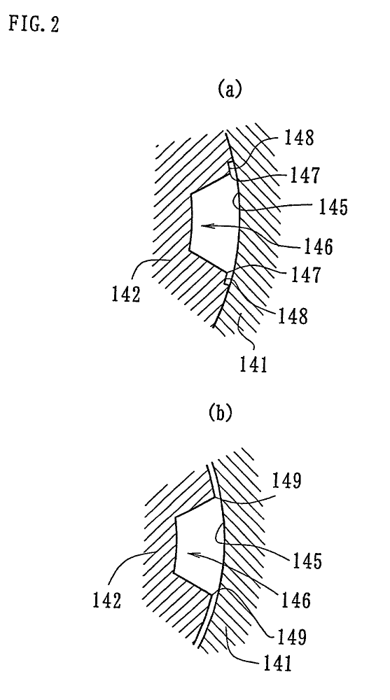

### DESCRIPTION OF THE PREFERRED EMBODIMENTS

Hereinafter, referring to the attached figures, a detailed description will be made of preferred embodiments of the present invention.

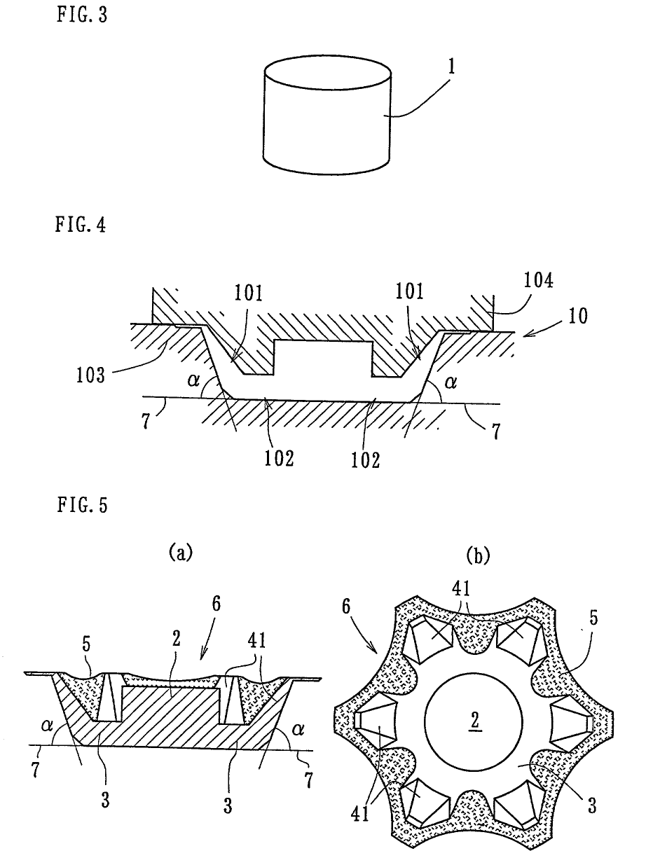

FIG. 3 to FIG. 12 illustrate the steps of these embodiment in order.

At the outset, as shown in FIG. 3, a round bar is press-cut at predetermined dimensions to prepare a material 1 having a predetermined volume. In order to minimize the material loss as well as to facilitate the following processes, it is preferred that the volume of the material 1 be prepared as precisely as possible. Further, various types of the round bars may be used; however, in general, a low-carbon-content magnetic material suitable for rotor core members is used.

In the next step, the above-mentioned material 1 is heated and then, as shown in FIG. 4, formed into a preliminary core blank 6 that approximates to the finished core member by means of forging using a set of dies 10 having a cavity structure such that, in the interior cavity, the angle α, which is formed by the die cavities 101 defining the respective pole piece fingers 41 and a plane 7 extended from the bottom face of a die cavity 102 defining an integral disc section 3, is 70°. Needless to say, the structures of the other portions in the interior cavity should be appropriate for forming the preliminary core blank 6 having structures to be described afterward. Further, the above-mentioned set of dies 10 is comprised of a lower die or drag 103 at the lower-side surface from among the surfaces defining the above-mentioned interior cavity, i.e., at the surface side where elements oriented upwardly are provided, and an upper die or cope 104 at the upper side, i.e., the side where elements oriented downwardly are provided.

FIG. 5A and FIG. 5B illustrate the preliminary core blank 6 formed by means of hot forging. That is to say, the above-mentioned preliminary core blank 6 is formed so as to be comprised of a boss section 2 and an integral disc section 3 each having dimensions approximating the finished core member, and a plurality of pole piece fingers 41 which are formed so that the length thereof is a little smaller than that of the finished core member and the angle α relative to the plane 7 extending from the bottom face of the above-mentioned integral disc section 3 is 70°.

As described above, since the dies 10 are separated into the upper die or cope 104 and the lower die or drag 103 at the portion described above, and the angle α is set to 70°, the above-mentioned material 1 is caused to flow very well into the die cavities 101 for forming the pole piece fingers 41 during forging processing. This is attributable to the facts that the material 1 is allowed to flow in adequate directions and that the material is no more allowed to escape.

Therefore, as a result, it is unnecessary to raise the pressure particularly within the dies in order to increase the flow of the material 1 and further it is unnecessary to produce a large forging burr as a means for raising the pressure. Accordingly, as for the volume of the above-mentioned material 1, it is unnecessary to take into consideration the amount of extra volume necessary for producing a large forging burr as described above. Accordingly, a material a little larger in volume than that of the finished core member is sufficient therefor.

At this step, the boss section 2 is not yet formed with a shaft aperture. In this step, as shown in FIG. 5A and FIG. 5B, a small amount of extra volume of the material 1 is produced into a thin forging burr 5 around the integral disc section 3 and the pole piece fingers 41.

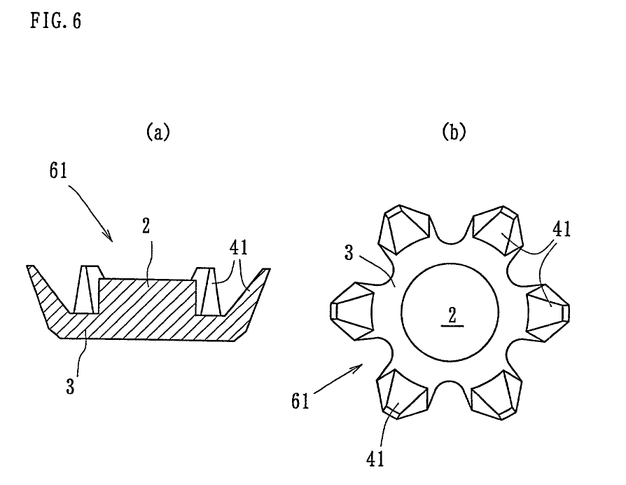

In the next step, the forging burr 5 is immediately removed from the preliminary core blank 6. This process is carried out by means of a conventional technique, i.e., die cutting using a press and dies for die cutting. FIG. 6A and FIG. 6B show a preliminary core blank 61, which has been processed by means of die cutting.

After completing the above-mentioned die cutting, gradual air-cooling is carried out. The gradual air-cooling may be carried out in such manner that, after completing the hot forging processing, the formed preliminary core blank 61 is placed in air until it is cooled down naturally. The gradual air-cooling provides the preliminary core blank with an annealing effect without carrying out any special annealing processing, resulting in advantageous effects in the following processes.

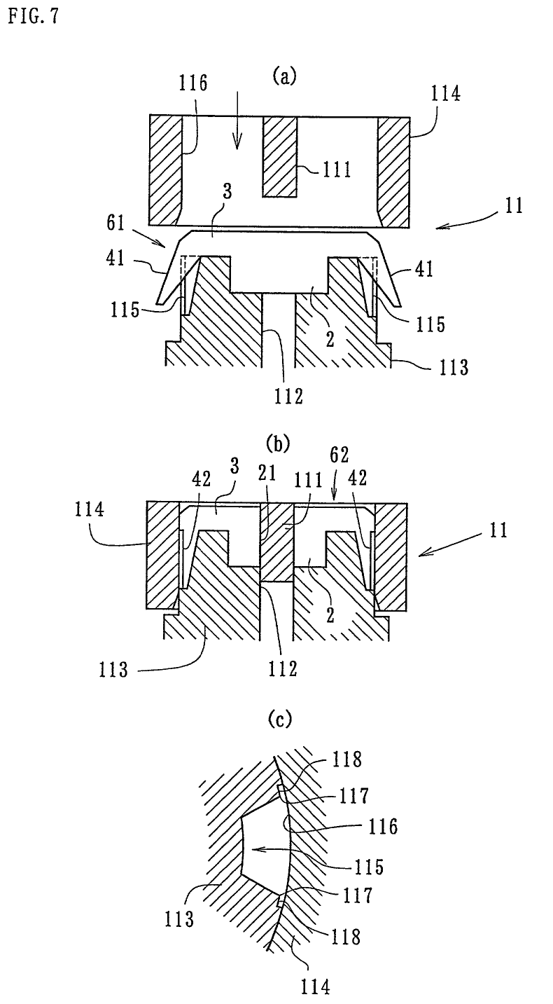

After completing the above-mentioned gradual air-cooling, as shown in FIG. 7A and FIG. 7B, using a set of the dies 11, the central boss section 2 of the preliminary core blank 61 is die-cut to form a shaft aperture 21 and, while being drawn by means of drawing processing, the pole piece fingers 41 are bent until the angle relative to the integral disc section 3 becomes 90°. At the same time, concave angular portions 42 for fixing permanent magnets are formed at both sides of the inside of the respective pole piece fingers 41. These steps are performed as a single action using the set of dies 11.

The above-mentioned set of the dies 11 is provided with, as shown in FIG. 7A, FIG. 7B and FIG. 7C, a die cavity in which a cope 114 is provided with a punch 111 for die-cutting to form the shaft aperture 21 at the center thereof, and the periphery thereof is provided with a die face 116 for forming the outer face of the pole piece fingers 41 in order to bend each of pole piece fingers 41 to 90° relative to the integral disc section 3 while carrying out the drawing processing.

Further, the above-mentioned set of dies 11 is, as shown in FIG. 7A, FIG. 7B and FIG. 7C, provided with a drag 113 having a cylindrical cavity for receiving the central boss section 2 at the center thereof, and further, at the center of the bottom of the cylindrical cavity, a die 112 having an aperture for receiving the above-mentioned punch 111 therein. The periphery of the die 112 is provided with die faces 115 for forming the inside faces 5 of the respective pole piece fingers 41. To described the die faces 115 more precisely, as shown in FIG. 7C, the die faces 115 are structured such that that convex angular portions 117 corresponding to the above-mentioned concave angular portions 42 are provided at both sides thereof, and a notches 118 are formed at both sides of the convex angular portions 117 for providing a thin sword-guard like cavity between the die face 116 which defines a die cavity for forming the outer faces of the pole piece fingers on the cope 114.

Accordingly, by using the dies 11, as shown in FIG. 7A and FIG. 7B, after placing the above-mentioned preliminary core blank 61 upside down on the drag 113, die-cutting begins when the cope 114 is lowered and the lower edge of the punch 111 at the center thereof comes into contact with the center of the central boss section 2 of the preliminary core blank 61 while holding the same. Immediately after that, the die face 116 of the cope 114 for forming the outer faces of the pole piece fingers come into contact with the pole piece fingers 41 of the preliminary core blank 61 and hold the preliminary core blank 61 in the same manner. Therefore, by virtue of the holding action on the preliminary core blank 61 by both the punch 111 and the above-mentioned die face 116 of the cope 114, under stable conditions, die-cutting of the shaft aperture 21 by the punch 111 and the die 112, as well as drawing and bending processing on the pole piece fingers 41 by the die face 116 of the cope 114 and the die faces 115 of the drag 113 for forming inside faces of the pole piece fingers 41 and forming of the concave angular portion 42, are carried out successfully.

As described above, accompanying lowering of the above-mentioned cope 114, at the same time, while carrying out drawing processing on the pole piece fingers 41 with the die face 116 which defines the die cavity of the cope 114 for forming the outer faces of the pole piece fingers 41, the pole piece fingers 41 are bent until the angle relative to the above-mentioned integral disc section 3 becomes 90°. Furthermore, by virtue of the bending, the inside faces of the pole piece fingers 41 are pressed resulting in forming of the concave angular portions 42 for fixing permanent magnets at both sides of each of the pole piece fingers 41. Therefore, in this case, as shown in FIG. 7B and FIG. 7C, since the pole piece fingers 41 are pressed at substantially an angle of 90° against the convex angular portions 117 at both sides of each of the die faces 115 on the drag 113 and the notches 118 at both sides thereof, the concave angular portions 42 are formed successfully.

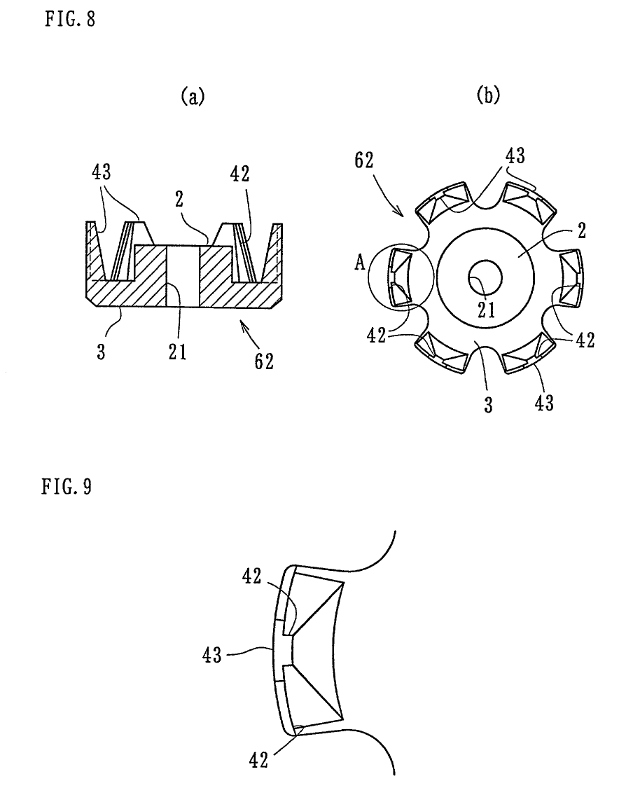

FIG. 8 and FIG. 9 show a preliminary core blank 62 which has been formed with the shaft aperture 21 in the boss section 2, while being drawn, the pole piece fingers 43 have been bent to 90° relative to the integral disc section 3, and the concave angular portions 42 have been formed at both inside faces on the pole piece fingers 43 by the above described steps.

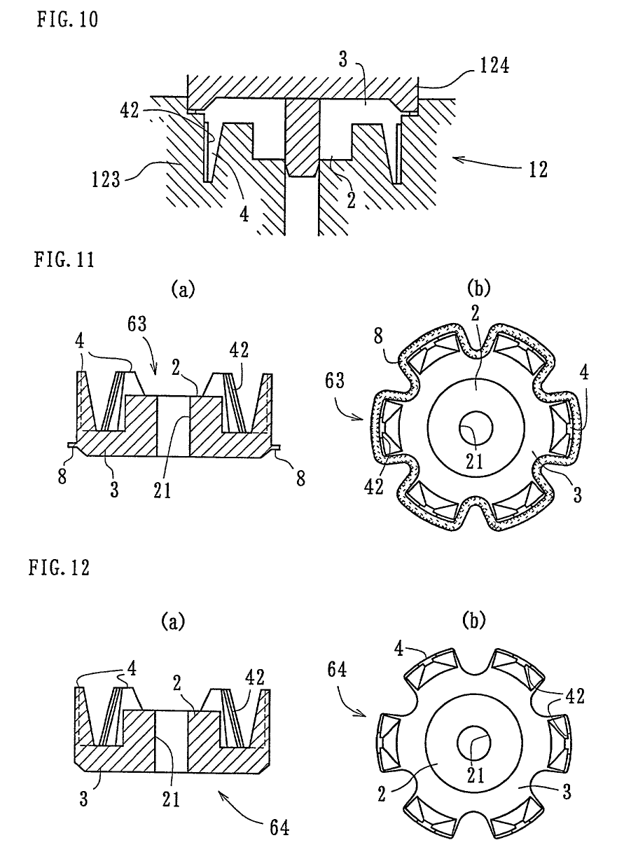

After that, the above-mentioned preliminary core blank 62 is, as shown in FIG. 10, re-pressed using a set of dies 12. The dies 12 are comprised of an upper die or cope 124 and a lower die or drag 123 of which the inside structures coincide with those of a finished core member 64 having precise predetermined dimensions.

The re-pressing is carried out in such a manner that the preliminary core blank 62 is placed on the drag 123 and then the cope 124 is lowered to press the core blank 62, resulting in the required structure of the finished core member 64.

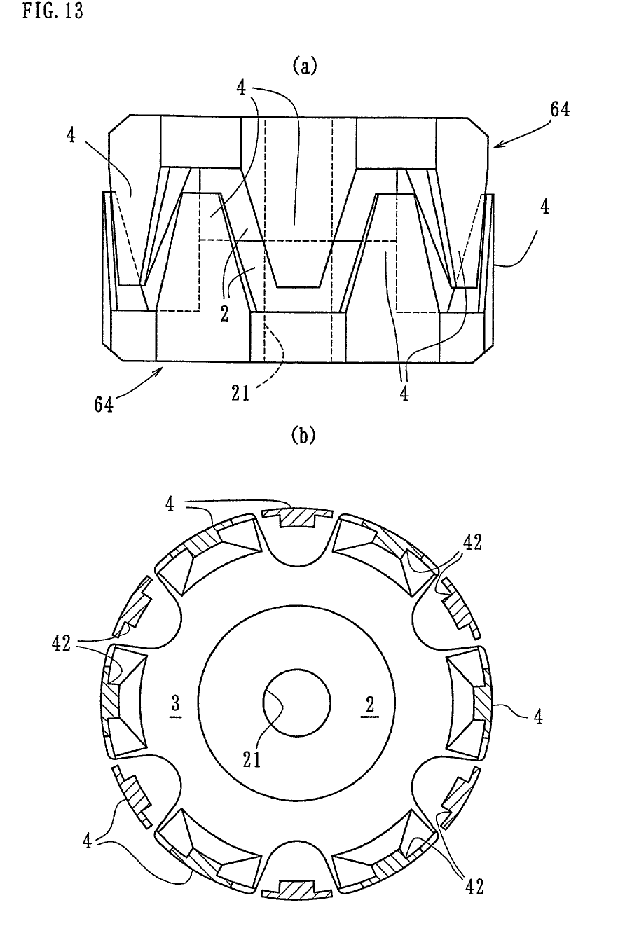

As a result of the re-pressing processing, as shown in FIG. 11A and FIG. 11B, an extra volume of the material is extruded as a forging burr 8 on the periphery of the integral disc section 3 of the preliminary core blank 63. This forging burr 8 is removed in a subsequent die-cutting processing using a press. Thus, as shown in FIG. 12A and FIG. 12B, the finished core member 64 having precise predetermined dimensions is obtained.

Consequently, according to the manufacturing method of the invention, it is made possible to easily manufacture a rotor core member, i.e., a rotor core member for a permanent magnet generator, which is provided with the concave angular portions 42 for fixing permanent magnets at both sides of the inside of the pole piece fingers 41, by means of a forging technique only, without using machining processing which is different from the other processing techniques.

Especially, since the concave angular portions 42 on the inside face of the pole piece fingers 41 for fixing permanent magnets are formed not in another step but in the step where the pole piece fingers are bent while being drawn, it is possible to manufacture the pole piece fingers 41 in an extremely easy manner.

Further, as shown in FIG. 13A and FIG. 13B, the pair of finished core members 64 are coupled with each other in such manner that the respective boss sections 2 are mated facing to each other and the pole piece fingers 4 of one are meshed into the spaces between the pole piece fingers 4 of the other. A rotor is constructed in such a manner that a common shaft is inserted into the shaft apertures 21 on the respective boss sections 2 and to fix the boss section 2 to each other, and magnets are inserted into the respective concave angular portions 42 which are adjacent to each other in the peripheral direction of the rotor.

What is claimed is:

1. A method of manufacturing a rotor core member for permanent magnet alternating-current generators, comprising the steps of:
forming a segment of a material having a predetermined volume into a preliminary core blank which includes a central boss section having dimensions approximating those of a finished core member, an integral disc section extending around the periphery thereof, and a plurality of pole piece fingers projecting at predetermined angular intervals from the integral disc section, the pole piece fingers being a little smaller in length than those of the finished core member and an angle thereof relative to the face extended from the bottom face of the integral disc section being 45° to 80°, said forming being carried out by means of forging using a set of dies having an interior structure in which a die cavity for forming the pole piece fingers rises at an angle of from 45° to 80° from the face extended from the bottom face of the die cavity for forming the integral disc section;
removing a forging burr produced in said forming step around the periphery of the integral disc section and at the both sides of the pole piece fingers of the preliminary core blank by means of die-cutting;
forming a shaft aperture by means of die-cutting at the center of the boss section of the preliminary core blank while, at the same time, drawing by means of drawing processing, bending the pole piece fingers to 90° relative to the integral disc section, and whereby the inside surfaces of the pole piece fingers are pressed onto a die face of a lower die for forming the pole piece fingers resulting in forming the concave angular portions for fixing permanent magnets to the insides at the both sides of the pole piece fingers; and
re-pressing the preliminary core blank whereby a finished core member having precise predetermined dimensions is obtained.
